(19) United States
(12) Patent Application Publication
(10) Pub. No.: US 2008/0149577 A1
(43) Pub. Date: Jun. 26, 2008

(54) RACK APPARATUS WITH RETAINING ELEMENT

(75) Inventors: CHIH-PEN LIN, Shindian (TW); YONG ZHANG, Shenzhen (CN); YUN HONG, Shenzhen (CN); ZHAN-GANG ZHU, Shenzhen (CN); QUN-GAO HU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRIAL CO,.LTD., Shenzhen (CN); SUTECH TRADING LIMITED, Tortola (VG)

(21) Appl. No.: 11/684,472

(22) Filed: Mar. 9, 2007

(30) Foreign Application Priority Data
Dec. 20, 2006 (CN) 200610157693.0

(51) Int. Cl. B25H 3/04

(52) U.S. Cl. 211/85.31

(57) ABSTRACT

A rack apparatus (100) includes a frame (110) and a plurality of retaining members (160) mounted on the frame. Each retaining member includes a plurality of retaining elements (166). Each retaining element includes a bracket (1662) and at least two arms (1664), an arm being respectively attached to each corresponding end of the bracket. Each arm includes a retaining portion (1668) bounding at least one opening (1669) therein.

### BACKGROUND OF THE INVENTION

1. Field of the Invention

The present invention generally relates to a rack apparatus, and, more particularly, to a rack apparatus used for retaining workpieces during coloring.

2. Description of Related Art

Dip-dyeing technology is widely used in coloring of workpieces. During coloring, metal workpieces need to be retained on rack apparatuses. The rack apparatuses are made up of a plurality of retaining elements. Referring to FIG. 5, the retaining element 10 is made of resilient metal and includes a bracket 12 and two arms 14. The bracket 12 is approximately U-shaped. The arms 14 are respectively connected to the two corresponding ends of the bracket 12 and extend along the same direction as the two ends of the bracket 12. The retaining element 10 is used to retain a workpiece 20 requiring coloration. The workpiece 20 is, for example, a metal board in which a through hole 22 is defined.

In use, the arms 14 of the retaining element 10 are pressed towards each other and inserted into the through hole 22 of the workpiece 20. When pressure on the arms 14 is released, the arms 14 resist an inside surface of the through hole in two contrary directions because of the resilient characteristic of the bracket 12. In this way, the workpiece 20 is attached to the retaining element 10. The retaining element 10 and the workpiece 20 are then placed into a dyeing container (not shown) to thereby submerse the workpiece 20 in the dye. After dyeing, the retaining element 10 and the workpiece 20 are taken out of the dyeing container, and the workpiece 20 is taken away from the retaining element 10.

However, when the retaining element 10 with the workpiece 20 together is placed in the dyeing container, the arms 14 cover a large area of the surface portion of the workpiece 20. Thus the arms 14 may block the dyeing of fairly large surface portions of workpiece 20, and dyeing quality is affected.

Therefore, an improved rack apparatus with retaining element are desired in order to overcome the above-described shortcomings.

### SUMMARY OF THE INVENTION

In one aspect, a retaining element includes a bracket and at least two arms respectively attached to a corresponding end of the bracket. Each arm includes a corresponding retaining portion, and each such corresponding retaining portion has at least one through hole defined therein.

In another aspect, a rack apparatus includes a frame and a plurality of retaining members mounted on the frame. Each retaining member includes a plurality of retaining elements. Each retaining element correspondingly includes a bracket and at least two arms respectively attached to a given end of the bracket. Each arm includes a retaining portion, and each retaining portion has at least one through hole defined therein.

Other advantages and novel features will become more apparent from the following detailed description when taken in conjunction with the accompanying drawings.

### BRIEF DESCRIPTION OF THE DRAWINGS

Many aspects of the present invention can be better understood with reference to the following drawings. The components in the drawings are not necessarily drawn to scale, the emphasis instead being placed upon clearly illustrating the principles of the present invention. Moreover, in the drawings, like reference numerals designate corresponding parts through out the several views.

FIG. 1 is a schematic view of a rack apparatus, in accordance with a preferred embodiment;

FIG. 2 is an enlarged schematic view of a main pole with some retaining elements of the rack apparatus shown in FIG. 1;

FIG. 3 is an enlarged schematic view of a retaining member shown in FIG. 2;

FIG. 4 is a schematic view of a retaining member shown in FIG. 3, used to retain a workpiece; and

FIG. 5 is a schematic view of a retaining element of a typical rack apparatus, shown in use to retain a workpiece.

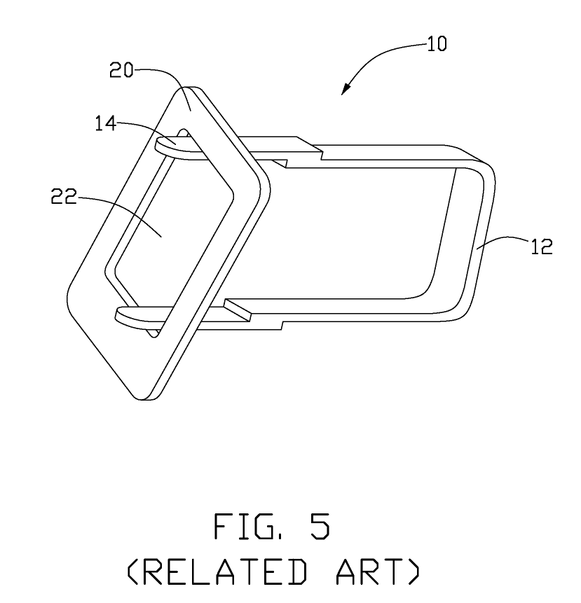

### DETAILED DESCRIPTION OF THE INVENTION

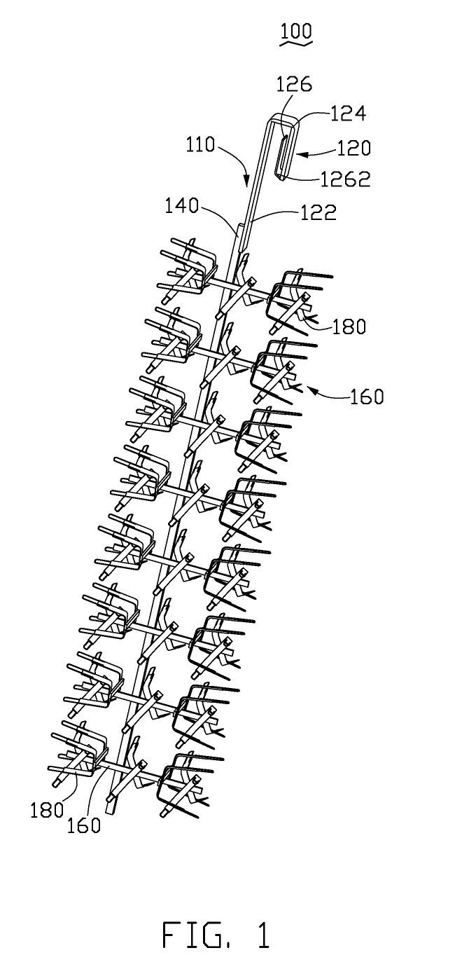

Referring now to the drawings in detail, FIG. 1 shows a rack apparatus 100, in accordance with a preferred embodiment. The rack apparatus 100 includes a frame 110 and a plurality of retaining members 160. The retaining members 160 are, advantageously, arranged on the frame 110 equidistantly.

The frame 110 is made of a mechanically and chemically durable metal, such as a titanium alloy, and includes a hanging member 120 and a pole member 140. One end of the hanging member 120 is connected to one end of the pole member 140. The hanging member 120 includes a connecting pole 122, a hook 124, and a biasing element 126. The hook 124 is connected to one end of the connecting pole 122, and the other end of the connecting pole 122 is directly joined (e.g., metallurgically bonded and/or bolted) to the pole member 140. An incurvate (i.e., inwardly curved) portion 1262 is formed on an end of the biasing element 126, and the biasing element 126 is connected to the hook 124 via the incurvate portion 1262. The pole member 140 is, usefully, a straight pole.

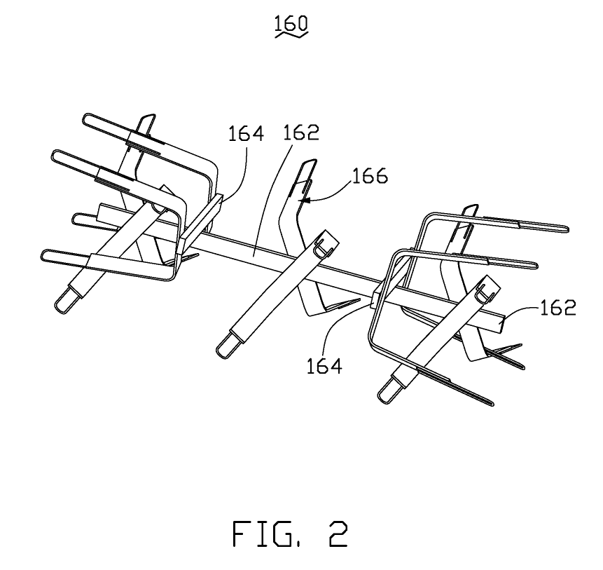

Referring to FIG. 2, each retaining member 160 is made of a mechanically and chemically durable metal, such as a titanium alloy, and includes a main pole 162, two subsidiary pole 164, and a plurality of retaining elements 166. The two subsidiary poles 164 are attached at two ends of the main pole 162, respectively, by their middle portions. The main pole 162 is approximately perpendicular to the subsidiary poles 164. The retaining elements 166 are mounted on the main pole 162 and the subsidiary poles 164 in alternating fashion. The main pole 162 of each retaining member 160 is perpendicularly mounted on the pole member 140.

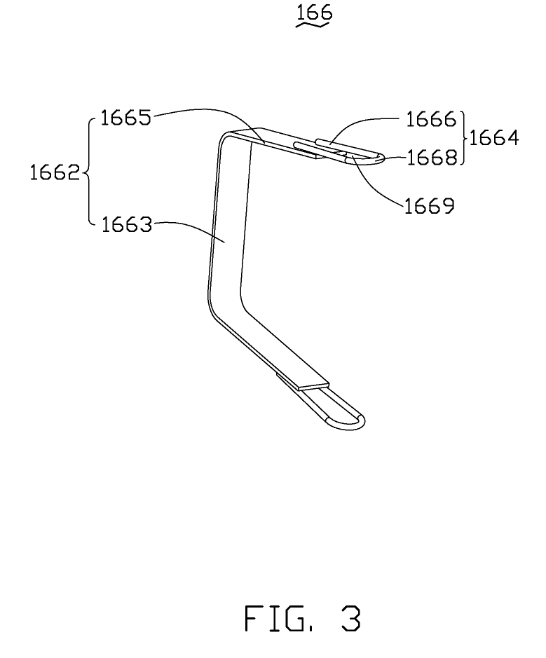

Referring to FIG. 3, each retaining element 166 includes a bracket 1662 and two arms 1664, which extend from opposing ends of the bracket 1662. The bracket 1662 incorporates a connecting portion 1663 and two extending portions 1665. The extending portions 1665 respectively directly extend from two ends of the connecting portion 1663 and, advantageously, are integrally formed with the connecting portion 1663, thereby forming a C-shape. Each arm 1664 is made, beneficially, of bent, heavy-gauge titanium alloy wire and includes two mounting portions 1666 and a retaining portion 1668. Each arm 1664 is bent to be approximately U-shaped, and an opening/aperture 1669 is defined within a central region bounded by the wire making up a given arm 1664 and by the distal end of an adjoining extending portion 1665. Each arm 1664 is mounted directly (e.g., via a metallurgical means such a welding or soldering) on an outside surface of a corresponding extending portion 1665. The material (e.g., a Ti alloy) of the bracket 1662 and the arms 1664 is advantageously resilient and corrosion-resistant.

A plurality of retaining elements 166 can be mounted on the main pole 162 and the subsidiary poles 164 via their respective connecting portions 1663. Each retaining element 166 attached to a side of the main pole 162 is, usefully, opposite to another retaining element 166 mounted on another side thereof, in order to maximize the number of retaining elements 166 that can be carried on the main pole 162. Each retaining element 166 is, opportunely, parallel with other retaining elements 166 attached to a same side of the main pole 162, as the more ordered arrangement helps increase retaining element density. Each retaining element 166 attached to the main pole 162 forms an angle of approximately 60 degrees to the main pole 162, to help ensure an adequate coloring/coating flow around proximate retaining elements 166. Each retaining element 166 attached to the subsidiary poles 164 is parallel with other retaining elements 166 attached to the same subsidiary pole 164.

In assembly, two subsidiary poles 164 are respectively connected to two ends of each main pole 162 by, e.g., means of soldering. Three retaining elements 166 are equidistantly and parallel mounted on a side of the main pole 162 via their connecting members 1663 by, e.g., means of soldering, and other three retaining elements 166 are equidistantly and parallel mounted on an opposite side of the main pole 162 via their connecting members 1663, also by, e.g., means of soldering. Each retaining element 166 mounted on a side of the main pole 162 is located corresponding to another retaining element 166 mounted on another side of the main pole 162. Each retaining element 166 mounted on the main pole 162 forms an angle of approximately 60 degrees with the main pole 162 and its corresponding retaining element 166 mounted on an opposite side of the main pole (i.e., at a 60° offset thereto). Additionally, two retaining elements 166 are mounted to the two ends of each subsidiary pole 164 by means of soldering. After the retaining elements 166 are mounted, a plurality of retaining members 160 with retaining elements 166 are equidistantly soldered on the pole member 140 of the frame 110. Finally, a hanging member 120, particularly via the connecting pole 122 thereof, is soldered to an end of the pole member 140 so as to finish the assembling process.

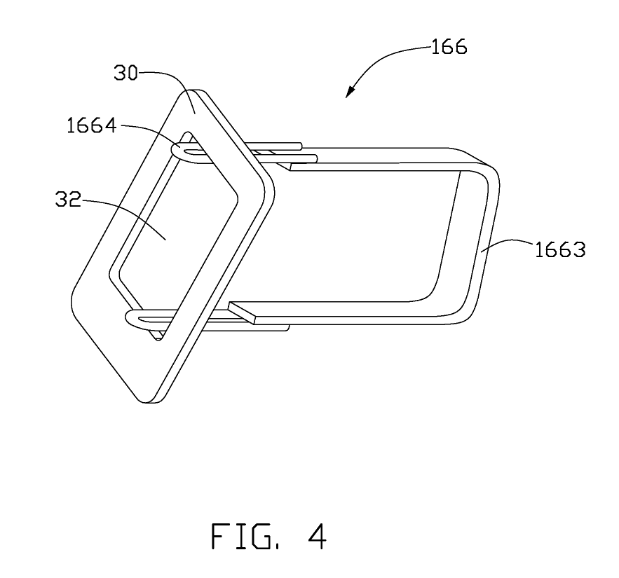

The rack apparatus 100 is used to retain workpieces 30 during dyeing process. Referring to FIG. 4, each workpiece 30 requiring dyeing has a rectangular through hole 32 defined therein. When the rack apparatus 100 is used to dye the workpieces 30, each retaining element 166 retains a workpiece 30. The two arms 1664 are pressed towards each other and inserted into the through hole 32. After the pressure on the arms 1664 is released, the arms 1664 resist (i.e., via an effective spring bias) an inside surface of the through hole 32 in two opposite directions. In this way, the workpieces 30 are retained on the retaining elements 166, and thus the rack apparatus 100 with workpieces 30 can be placed into a dye container (not shown) for dyeing. After dyeing, the rack apparatus 100 and the workpieces 30 are taken out of the dyeing container, and the workpieces 30 are taken out of the rack apparatus 100.

In this rack apparatus 100, the arms 1664 are formed using titanium alloy wire. In this way, the surface area of the workpieces 30 unable to come into contact with the dye during coloring is minimized due to the small contact area offered by the wire arms 1664, thereby facilitating more complete colorizing of a given workpiece 30.

Understandably, the frame 110 and the retaining members 160 can be replaced with other shapes and structures according to differing demands. For example, a plurality of retaining members 160 can be radially mounted on the frame 110. The retaining elements 166 of the retaining members 160 can be mounted to the frame 110 directly. The number and position of the retaining members 160 and the retaining elements 166 can also be changed. For example, the angle between a connecting portion 1663 and the main pole 162 or the subsidiary poles 164 connected with the connecting portion 1663, and the angle between a main pole 162 and a subsidiary pole 164 connected to the main pole 162 can all be changed. If the main pole 162 is long, a plurality of subsidiary poles 164 can be, usefully, equidistantly mounted on the main pole 162.

Additionally, each arm 1664 can be of other shapes having a small contacting area with each workpiece 30, such as a board defining at least one hole/opening therein. If a width of the bracket 1662 is large, a plurality of arms 1664 can be mounted side by side on each end of the bracket 1662. The bracket 1662 and the arms 1664 of each retaining element 166 can also be formed integrally.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A retaining element, comprising:
a bracket having at least a pair of ends; and
at least two arms respectively extending from a given end of the bracket, each arm including a corresponding retaining portion, the corresponding retaining portion bounding at least one opening.

2. The retaining element as claimed in claim 1, wherein the bracket and the arms all have resilient characteristics.

3. The retaining element as claimed in claim 1, wherein each arm is made of a bent titanium alloy wire.

4. The retaining element as claimed in claim 1, wherein the bracket includes a connecting portion and two extending portions, the two extending portions defining the pair of ends of the bracket, a given arm extending from a corresponding extending portion.

5. The retaining element as claimed in claim 4, wherein a given arm is directly attached to a corresponding extending portion.

6. A rack apparatus, comprising:
a frame; and
a plurality of retaining members mounted on the frame, each retaining member including a plurality of retaining elements, each retaining element including:
a bracket having at least a pair of ends; and
at least two arms respectively extending from a given end of the bracket, each arm including a corresponding retaining portion, the corresponding retaining portion bounding at least one opening.

7. The rack apparatus as claimed in claim 6, wherein the frame includes a hanging member and a pole member, one end of the hanging member is connected to one end of the pole member, and a hook is formed on another end of the hanging member.

8. The rack apparatus as claimed in claim 6, wherein at least one retaining element is mounted on the main pole so as to form an angle with the main pole.

9. The rack apparatus as claimed in claim 8, wherein at least one retaining element is mounted on the main pole so as to form an angle with the main pole.

10. The rack apparatus as claimed in claim 8, wherein at least two retaining elements are mounted to the two ends of each subsidiary pole.

11. The rack apparatus as claimed in claim 6, wherein each arm is made of a bent titanium alloy wire.

12. The rack apparatus as claimed in claim 6, wherein the frame and the retaining members are all made of a resilient and corrosion-resistant metal.
